(19) United States
(12) Patent Application Publication
(10) Pub. No.: US 2007/0047059 A1
(43) Pub. Date: Mar. 1, 2007

(54) Illumination path shifting

(76) Inventors: P. Guy Howard, Junction City, OR (US); Anurag Gupta, Corvallis, OR (US); Scott Lerner, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/218,169

(22) Filed: Aug. 31, 2005

(51) Int. Cl. G02F 1/01

(52) U.S. Cl. 359/277

(57) ABSTRACT

A projection assembly includes an illumination system and at least one light modulator panel in optical communication with the illumination system. An illumination path is defined between the illumination system and the light modulator panel. Further, the illumination system is configured to spatially shift at least a portion of the illumination path.

### BACKGROUND

Display systems display an image or series of images on a display surface. In particular, each image is frequently made up of several sub-images. For example, some systems produce a red, a green, and a blue sub-image that are then combined to form a single, full-color image.

Recent designs have made use of lasers to provide the red, green, and blue light. Lasers frequently allow for the formation of relatively bright images. Such lasers frequently produce light with relatively high spatial coherence. Light produced by the lasers is frequently scattered by directing the light to a scattering member. Scattering members are often shaped so as to disperse the light over a larger area. The scattering members often have several “scatter centers” from which the incident light is scattered.

These scatter center produce randomly scattered beams across the screen. The randomly scattered beams distributed across the screen may interfere with each other where the image is perceived, such as by the human eye. This interference forms distinct patterns, which is commonly referred to as speckle.

Some designs rapidly scan individual points of laser light across the screen to form an image, in a similar fashion as that used by cathode ray tube systems, in an attempt to use laser light while minimizing speckle due to scattering. Such designs may be costly and complicated.

### SUMMARY

A projection assembly includes an illumination system and at least one light modulator panel in optical communication with the illumination system. An illumination path is defined between the illumination system and the light modulator panel. Further, the illumination system is configured to spatially shift at least a portion of the illumination path.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic view of a display system according to one exemplary embodiment.

FIG. 2 illustrates a method of modulating light according to one exemplary embodiment.

FIG. 3 is a schematic view of a projection assembly according to one exemplary embodiment.

Throughout the drawings, identical reference numbers designate similar, but not necessarily identical, elements.

### DETAILED DESCRIPTION

An illumination system is provided herein for use in display systems. According to one exemplary embodiment, the display system includes an illumination system, a light modulator assembly, and display optics. The illumination system includes a light source, such as one or more lasers and an illumination optics assembly. Light generated by the light source travels through the illumination optics assembly to the light modulator assembly along an illumination path.

At least one of the components of the illumination system is moved, such as by vibration and/or rotation to thereby selectively spatially shift a portion of the illumination path before the light reaches the light modulator assembly. The light modulator panel then modulates the light to form a full-image or sub-image. By spatially shifting the illumination path at a frequency greater than the integration time of the human eye, the speckle can be reduced. An exemplary display system will first be discussed, followed by a discussion of an exemplary method of modulating light and an exemplary projection assembly.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

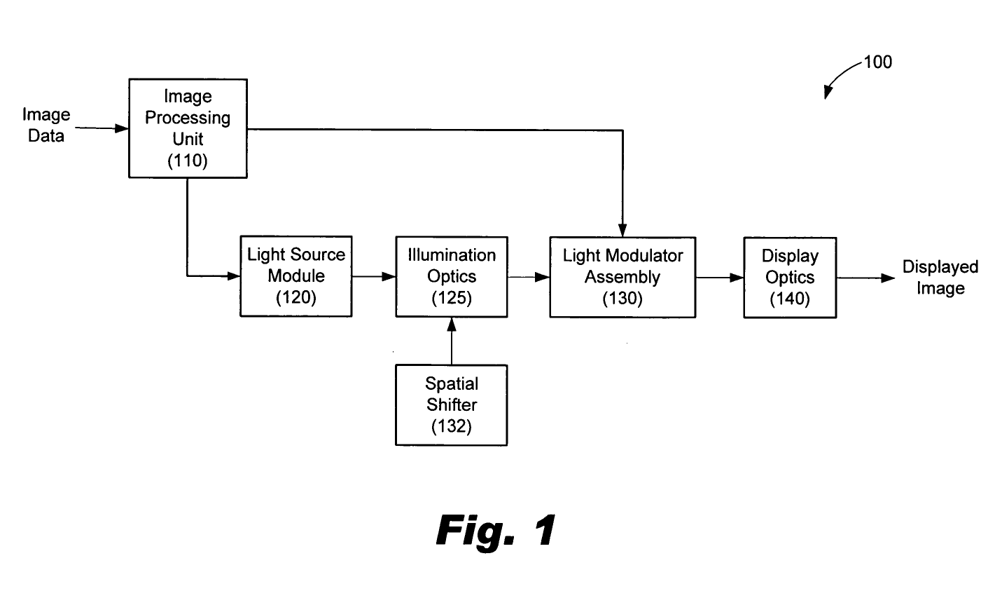

FIG. 1 is a schematic view of a display system (100) according to one exemplary embodiment. The components of FIG. 1 are exemplary only and may be modified or changed as best serves a particular application. As shown in FIG. 1, image data is input into an image processing unit (110). The image data defines an image that is to be displayed by the display system (100).

While one image is illustrated and described as being processed by the image processing unit (110), it will be understood by one skilled in the art that a plurality or series of images may be processed by the image processing unit (110). The image processing unit (110) performs various functions including controlling the illumination of a light source module (120) and controlling a light modulator assembly (130).

The light source module (120) includes at least one light source. According to one exemplary embodiment, the light source module includes one or more coherent light source, such as one or more laser light source. While a coherent light source will be described, those of skill in the art will appreciate that any type of light source may be used. According to one exemplary embodiment, the light source module (120) includes red, green, and blue coherent light sources. The light from each of the light sources may be used to form individual sub-images at a sufficiently high rate that when viewed sequentially are perceived as a single, full-color image.

In particular, according to one exemplary embodiment, light is directed from the light source module (120) along an illumination path through illumination optics (125) to the modulator assembly (130). As the laser light travels through the illumination optics (125), the path of the light is shifted by a spatial shifter (132). The scattered laser light, which has at least a portion of its illumination path shifted, is incident on the light modulator assembly.

The spatial shifter (132) is configured to move one or more components of the illumination optics (125), such as by vibration or rotation, thereby shifting at least a portion of the illumination path across the light modulator assembly (130). Shifting the illumination path may increase the uniformity of light from the light source module (120) across the light modulator assembly (130) and may also reduce the speckle of the scattered laser light.

The light incident on the light modulator assembly may be modulated in its phase, intensity, polarization, or direction by the light modulator assembly (130) to form substantially full images or sub-images. The light modulated by the light modulator assembly (130) is then directed to display optics (140).

The display optics (140) may include any device configured to display or project an image. For example, the display optics (140) may be, but are not limited to, a lens configured to project and focus an image onto a viewing surface. The viewing surface may be, but is not limited to, a screen, a television such as a rear projection-type television, wall, liquid crystal display (LCD), or computer monitor. An exemplary method of modulating light in a light modulator assembly will now be discussed.

Method of Modulating Light

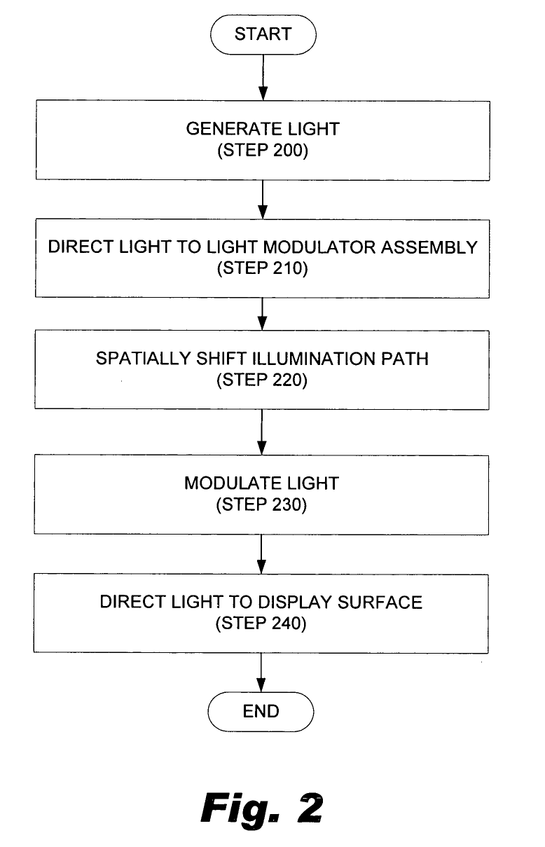

FIG. 2 is a flowchart illustrating a method of modulating light. The method begins by generating at least one beam of light (step 200). According to one exemplary embodiment, generating light includes forming multiple component beams of light. The light may be of any type, such as coherent light, including laser light. Further, the light may be generated to form sequentially color-varying light. According to one particular method, a first component laser beam such as a red laser beam may first be generated, followed by a second component laser beam such as a green laser beam, and finally a third component beam is generated, such as a blue laser beam. Each component beam may be used to form sub-images, as will be discussed below.

The component beams are then directed along an illumination path (step 210). The illumination path extends from the light source to at least one light modulator panel. As the component beams travel along the illumination path, they pass through an illumination optics assembly. The illumination optics assembly and the light source(s) used to generate the light form an illumination system.

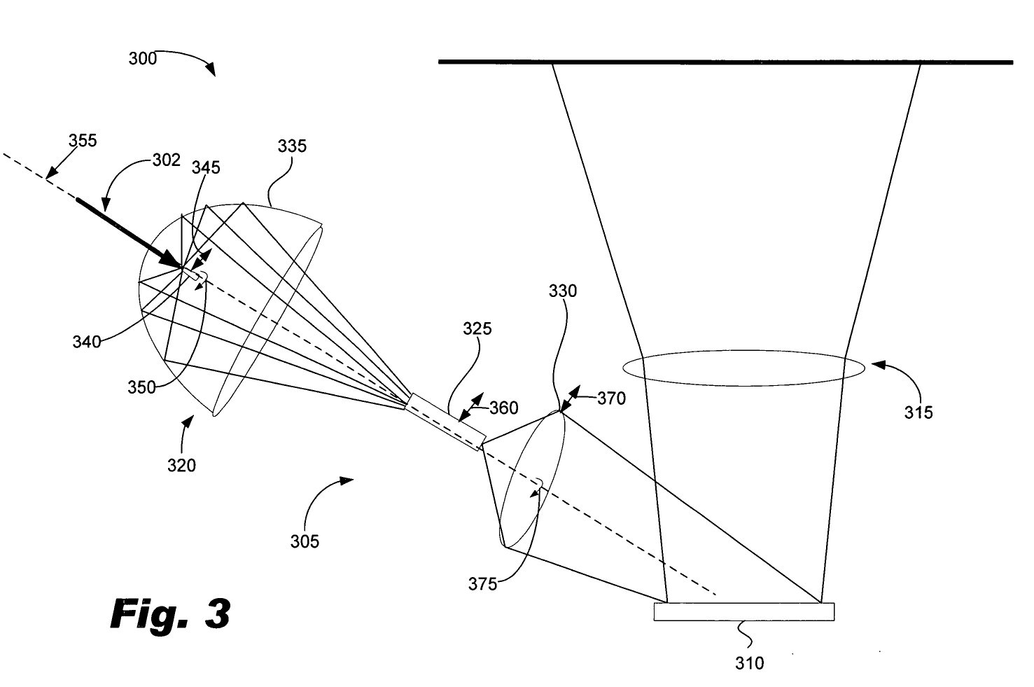

At least one part or component of the illumination system is moved to spatially shift the illumination path as the light is directed to a light modulator panel (step 220). Several exemplary components and their corresponding movement will be discussed in more detail below with reference to FIG. 3.

The light directed to the modulator panel covers a substantial portion of the light modulator panel. This light is then modulated (step 230) to form a full image or sub-image. The modulated light is then directed along a projection path (step 240) to display an image or sub-image on a display surface.

Projection Assembly

FIG. 3 is a schematic view of a projection assembly (300) that includes illumination optics (305), a light modulator panel (310), and display or projection optics (315) according to one exemplary embodiment. At least one component of the illumination optics (305) is moved, such as through rotation and/or vibration, to increase the uniformity of light directed to the light modulator panel (310) and/or to reduce speckle effects, as will be discussed in more detail below. Together with a light source, the illumination optics form an illumination system.

The projection assembly (300) receives light (302), from a light source module. As introduced, the light source module may generate any type of light, such as coherent light, which may include laser light. The light is first directed to the illumination optics (305). According to one exemplary embodiment, the illumination optics (305) includes a scattering assembly (320), an integrating tunnel (325), and a condenser lens (330).

Light (302) produced by the light source module (130; FIG. 1) is directed to the scattering assembly (320). The scattering assembly (320) includes a reflector (335) and a nose cone (340). The nose cone (340) is located at or near the focal point of the reflector (335). The light (302) passes through an opening in the reflector (335) and is incident on the nose cone (340). The nose cone (340) is coated with a highly reflective material that scatters the light. The scattered light is directed to the reflector (335), which directs the light to the integrating tunnel (325).

In particular, the reflector (335) focuses the now scattered light onto a front face of the integrating tunnel (325). Thus, a substantial portion of the laser light is transmitted to the integrating tunnel (325). The integrating tunnel (325) according to the present exemplary embodiment includes reflecting surfaces formed along the sides thereof. As light is transmitted through the integrating tunnel (325), it is reflected off of the reflecting side surfaces. This reflection spatially homogenizes the light. As a result, light exiting the integrating tunnel (325) is more spatially homogenous than it would otherwise be. To further increase the uniformity of light directed to the modulator panel (302) and/or to reduce the speckle, the integrating tunnel (325) may be vibrated at an amplitude that is greater than the spatial frequency of the speckle and with a frequency that is higher than the integration rate of the eye. For example, the integrating tunnel (325) may be vibrated at an amplitude greater than about 2 microns with a frequency greater than about 60 Hz.

The condenser lens (330) images the exit face of the integrating tunnel (325). The condenser lens (330) concentrates this light and focuses the light onto the light modulator panel (310). In particular, according to one exemplary embodiment the light from the condenser lens (330) slightly over fills the optical modulator to reduce light fluctuation across the displayed image due to vibration or movement of the components of the illumination optics (305) or the light source.

The light modulator panel (310) according to the present exemplary embodiment is a reflective-type modulator panel (310). The light modulator panel (330) includes an array of individual pixels. Each individual pixel includes a reflective plate that is selectively tilted. For example, according to the present exemplary embodiment, the reflective plate of an un-activated pixel may remain un-tilted or flat. Similarly, according to the present exemplary embodiment, the reflective plate of an activated pixel may be tilted to direct light incident thereon toward the display optics (315).

By controlling the frequency with which each pixel of the light modulator panel (310) is activated, the light modulator panel (310) is able to produce an output that varies between light and dark. Thus, the output may form an image having portions that vary from light to dark. Further, the light may be sequentially color-varying light. Accordingly, by controlling the output of the light modulator panel (310) when a color of light is directed thereon, the light modulator panel (310) may form sequential sub-images. When the sub-images are formed with sufficient frequency, the sub-images will be perceived as a single full-color image.

As introduced, the path of light directed to the light modulator panel (310) may be selectively shifted to reduce speckle effect. Several exemplary shifting components will now be discussed in more detail. The light source module (130; FIG. 1), the scattering assembly (320), including the reflector (335) and/or the nose cone (340); the integrator tunnel (325) and/or the condenser lens (330) may be selectively rotated and/or shifted. By selectively moving one or more of these components, the speckle due to the coherence of the laser light may be reduced.

For example, according to one exemplary embodiment, the nose cone (340) may be moved by a vibrating force (345) at its position with a small amplitude, such as a displacement of about 2 microns or greater at a frequency that is greater than the integration rate of the human eye, or at a frequency greater than about 60 Hz. For example, the displacement of the nose cone (340) may be greater than about 2 microns and less than about 10 microns. The integration rate of the human eye refers to the frequency below which a series of images will not be perceived individually, but rather will be perceived as a continuously moving scene. By vibrating the nose cone at a rate that is faster than the integration rate, individual light patterns of speckle are smeared, or appear as an area covered by light rather than individual patterns.

Further, the nose cone (340) may be rotated by a rotational force (350). By rotating and/or vibrating the nose cone (340), the path of the light incident thereon is spatially shifted at a relatively high frequency. Spatially shifting the light may improve the uniformity of the light directed to the light modulator panel (310). The spatial shifting of the light due to rotation also smears out or reduces the speckle effect caused due to the coherence of the light.

Additionally, the integrating tunnel (325) may also shift the path of the light along the illumination path. For example, the integrating tunnel (325) may lie along an optical axis (355) of the illumination optics. According to such an exemplary embodiment, a vibrating force (360) and/or rotating force (365) may be applied to the integrating tunnel (325) to move the integrating tunnel (325) perpendicular to the optical axis (355) at a rate greater than the integration rate of the human eye to thus increase the uniformity of light across the light modulator panel (310) and to reduce speckle as previously discussed. Further, a vibrating force (370) and/or rotational force (375) may be applied to the condenser lens (330).

In addition to moving components of the illumination optics, the projection assembly may also increase uniformity of light from the illumination source by moving the light source. For example, one or more light source, such as one or more laser light source may be vibrated and/or rotated to spatially shift the illumination path. In short, any component of the optical path may be moved, such as by vibration and/or rotation, to increase uniformity of the light across the light modulator panel (310) and/or to reduce speckle. In fact multiple components can be shifted at high frequency and appropriate amplitude to amplify the effect of speckle reduction.

In conclusion, an illumination system has been herein for use in display systems. According to one exemplary embodiment, the display system includes an illumination system, a light modulator assembly, and display optics. The illumination system includes a light source, such as one or more coherent light sources and an illumination optics assembly. Light generated by the light source travels through the illumination optics assembly to the light modulator assembly along an illumination path.

At least one of the components of the illumination system is moved, such as by vibration and/or rotation to thereby selectively spatially shift a portion of the illumination path before the light reaches the light modulator assembly. The light modulator panel then modulates the light to form a full-image or sub-image. By spatially shifting the illumination path, the illumination system provides for the increase in the uniformity of light across one or more light modulator panels and/or the reduction of speckle.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A projection assembly, comprising:
an illumination system, and
at least one light modulator panel in optical communication with said illumination system, wherein an illumination path is defined between said illumination system and said light modulator panel and wherein said illumination system is configured to spatially shift at least a portion of said illumination path relative to said at least one light modulator panel.

2. The assembly of claim 1, wherein said illumination system includes at least one coherent light source and an illumination optics assembly in optical communication with said coherent light source.

3. The assembly of claim 2, wherein coherent light source includes a laser light source.

4. The assembly of claim 1, wherein said light source is configured to be moved to spatially shift said illumination path.

5. The assembly of claim 1, wherein said light modulator panel comprises a reflective-type light modulator panel.

6. The assembly of claim 1, and further comprising display optics in optical communication with said light modulator panel.

7. The assembly of claim 1, wherein said illumination optics assembly includes a scattering assembly, an integrating tunnel, and a condenser lens.

8. The assembly of claim 7, wherein said scattering assembly includes a reflector having a focal point and a nose cone located at said focal point.

9. The assembly of claim 8, wherein said nose cone is configured to be vibrated at a displacement greater than about 2 microns at a frequency that is greater than about 60 Hz.

10. The assembly of claim 8, wherein at least one of said reflector and said nose cone is configured to be rotated.

11. The assembly of claim 8, wherein an illumination axis is defined substantially parallel to said illumination path and said integrating tunnel is configured to be vibrated substantially normal to said illumination axis.

12. A scattering assembly, comprising:
a reflector having a focal point; and
at least one nose cone located at said focal point, said nose cone being configured to be selectively moved.

13. The assembly of claim 12, wherein said nose cone is configured to be vibrated at a displacement of between about 2 to about 10 microns at a frequency that is greater than about 60 Hz.

14. The assembly of claim 12, wherein at least one of said reflector and said nose cone is configured to be rotated.

15. A method of modulating light, comprising:
generating light;
directing said light to a light modulator panel;
spatially shifting a path of said light before said light is incident on said light modulator panel; and
modulating said light.

16. The method of claim 15, wherein directing said light to said light modulator panel includes passing said light through an illumination optics assembly.

17. The method of claim 16, wherein passing said light through said illumination optics assembly includes passing said light through components including at least one of a) a scattering assembly having a reflector and a nose cone, b) an integrating device, and c) a condenser lens.

18. The method of claim 17, wherein spatially shifting said path of said light includes moving at least one component of said illumination optics assembly.

19. The method of claim 18, wherein spatially shifting said path of said light includes moving more than one of said components of said illumination optics assembly.

20. The method of claim 15, wherein the light is created by a laser and wherein spatially shifting a path of said light includes moving said laser.

21. A display system, comprising:
means for generating light;
means for modulating light; and
means for spatially shifting a path of said light between said means for generating light and said means for modulating light.

22. The system of claim 21, wherein said means for generating light includes means for generating laser light.

23. A method of using a force to make light from a light source more uniform when illuminated on a light modulator panel, comprising,
directing the light along an illumination path from the light source to the light modulator panel through an illumination optics assembly; and
applying the force to at least one component of the illumination optics assembly to shift the light across the light modulator.

24. The method of claim 23 wherein the force is linear.

25. The method of claim 23 wherein the force is rotational.

26. The method of claim 23 wherein the light is coherent and wherein to make light more uniform includes reducing speckle effects.

27. The method of claim 23 wherein the force is applied at a frequency greater than the integration rate of an eye.

28. The method of claim 23 wherein the light includes multiple component beams of light and the force is applied to at least one of the multiple component beams.

29. The method of claim 23 wherein the illumination optics assembly includes an integrating tunnel and wherein the force is applied perpendicular to an optical axis of the light.

30. The method of claim 23 wherein the step of applying the force to at least one component of the illumination optics assembly includes applying multiple forces to shift multiple components.
